(19) United States
(12) Patent Application Publication
(10) Pub. No.: US 2022/0169803 A1
(43) Pub. Date: Jun. 2, 2022

(54) METHOD FOR MECHANICALLY PREPARING AN EMULSION OF AN AMINO-FUNCTIONAL POLYORGANOSILOXANE

(71) Applicant: Dow Silicones Corporation, Midland, MI (US)

(72) Inventors: Robert Larsen, Midland, MI (US); Michael Toepke, Midland, MI (US)

(21) Appl. No.: 17/437,453

(22) PCT Filed: Mar. 2, 2020
(86) PCT No.: PCT/US2020/020591

§ 371 Date: Sep. 9, 2021

Related U.S. Application Data
(60) Provisional application No. 62/845,512, filed on May 9, 2019.

(51) Int. Cl. C08J 3/05; C08L 83/08

(52) U.S. Cl. CPC C08J 3/05; C08L 2201/54; C08J 2383/08; C08L 83/08

(57) ABSTRACT

A method produces an emulsion comprising an amino-functional polyorganosiloxane having low cyclic siloxane content. The method involves mechanical emulsification and devolatilization in one twin screw extruder.

### CROSS REFERENCE TO RELATED APPLICATIONS

This application claims the benefit of U.S. Provisional Patent Application Ser. No. 62/845,512 filed on May 9, 2019 under 35 U.S.C. § 119 (e). U.S. Provisional Patent Application Ser. No. 62/845,512 is hereby incorporated by reference

### TECHNICAL FIELD

A method for making an emulsion of an amino-functional polyorganosiloxane is disclosed. The emulsion contains a low amount of certain cyclic polydiorganosiloxanes. The emulsion is suitable for use in the personal care industry in hair care compositions such as shampoos and conditioners

### BACKGROUND

One method to prepare emulsions of amino-functional polyorganosiloxanes involves emulsion polymerization techniques, where siloxane monomers are first emulsified and then subsequently polymerized to a high molecular weight. However, this method suffers from the drawback that the resulting emulsion may contain relatively high amounts of cyclic polydiorganosiloxane impurities such as octamethylcyclotetrasiloxane (D4) in amounts>0.25% in the polyorganosiloxane phase of the emulsion, and decamethylcyclopentasiloxane (D5) in amounts>0.22%. Without wishing to be bound by theory, it is thought that the relatively high content of cyclic polydiorganosiloxanes results because the polymerization reaction is often ring-opening polymerization of cyclic polydiorganosiloxanes such as D4, and ring-chain equilibria dictate that there may be 8% D4 and 5% D5 in such a mixture after polymerization. Furthermore, regardless of the starting materials used to form the amino-functional polyorganosiloxane, ionic surfactants used in the emulsions for personal care compositions may also catalyze formation of cyclic polydiorganosiloxanes. And, cyclic polydiorganosiloxanes cannot easily be removed from an emulsion without destroying it.

Alternatively, amino-functional polyorganosiloxanes have been devolatilized to remove cyclic polydiorganosiloxanes by heating in a batch vessel at 150° C. for 6 to 12 hours and bubbling nitrogen through the vessel before emulsification. However, this method suffers from the drawback that due to the long exposure to elevated temperatures, the amino-functional polyorganosiloxane may degrade, as evidenced by the amino-functional polyorganosiloxane increasing in viscosity, developing an undesirable odor, and/or developing an undesirable color. Mechanical emulsions of amino-functional polyorganosiloxanes have been prepared, but still contain relatively high amounts of cyclic polydiorganosiloxanes, and these amounts can increase over time (e.g., to >0.22% D4). This renders these emulsions poorly suited for modern personal care applications, such as hair care, where low cyclics content may be desired by customers.

There is an industry need for a method of making an emulsion of an amino-functional polyorganosiloxane having low content of certain cyclic polydiorganosiloxanes while minimizing or eliminating degradation of the amino-functional polyorganosiloxane.

### BRIEF DESCRIPTION OF THE DRAWINGS

FIG. 1 is a schematic of the twin screw extruder used the examples herein.

FIG. 2 is a schematic of a twin screw extruder useful in a method for mechanically making an emulsion of an amino-functional polyorganosiloxane.

### REFERENCE NUMERALS

100 twin screw extruder
101 first inlet port
102 second inlet port
103 mixing zone
104 devolatilization zone
105 stripping gas inlet
106 stripping gas inlet
107 third inlet port
108 emulsification zone
109 devolatilization vent
110 devolatilization vent
111 devolatilization vent
112 devolatilization vent
113 outlet port
114 conveying element
115 pumping element
116 liquid seal
117 liquid partially filling the barrel
118 barrel
119 screw
120 emulsifying element

### Summary

A method for mechanically making an emulsion comprises devolatilizing an amino-functional polyorganosiloxane to lower content of cyclic polydiorganosiloxanes and emulsifying the resulting devolatilized amino-functional polyorganosiloxane with starting materials comprising a non-ionic surfactant and water. The method steps of devolatilizing and emulsifying are performed in one twin screw extruder.

### DETAILED DESCRIPTION

A method for mechanically preparing an emulsion of is disclosed. The method comprises:

1) heating a carrier to a temperature of >100° C. to 300° C.;

2) mixing an amino-functional polyorganosiloxane at a temperature of 20° C. to 50° C. and the carrier heated in step 1), thereby forming a mixture comprising the amino-functional polyorganosiloxane and the carrier at a devolatilization temperature of 100° C. to 200° C.;

3) devolatilizing the mixture;

where steps 2) to 3) are performed in a time≤180 s;

4) cooling the mixture to less than 50° C.;

5) emulsifying starting materials comprising the amino-functional polyorganosiloxane, a non-ionic surfactant, and water;

where steps 2) to 5) are performed in one twin screw extruder. The method may optionally further comprise removing the carrier after step 2).

In this method, step 1) may be performed before feeding the carrier into the one twin screw extruder (TSE). Step 1) may be performed by feeding the carrier through a heat exchanger or mixer such as a static mixer, which may be used for heating the carrier before feeding the carrier into a mixing zone of the TSE. Alternatively, step 1) may be performed in the TSE. For example, the TSE may be externally heated and/or the carrier may be volumetrically heated inside the TSE using shaft work from the screws to bring the carrier to temperature.

In step 2) the amino-functional polyorganosiloxane may be introduced into the mixing zone of the TSE. The amino-functional polyorganosiloxane is introduced at low temperature, e.g., 20° C. to 50° C. Mixing the carrier at >100° C. to 300° C. and the amino-functional polyorganosiloxane at 20° C. to 50° C. forms a mixture comprising the carrier and the amino-functional polyorganosiloxane at a devolatilization temperature of 100° C. to 300° C., alternatively 100° C. to 250° C., and alternatively 100° C. to 200° C.

The mixture can be passed from the mixing zone into a devolatilization zone of the TSE. Alternatively, the amino-functional polyorganosiloxane or the carrier, or both, may be introduced into a (first) devolatilization zone of the TSE. Alternatively, when both are added to the devolatilization zone, a separate mixing zone may be eliminated and mixing may be performed with in the devolatilization zone (e.g., within the first devolatilization zone, when more than one devolatilization zone is present). The TSE may have 1 to 6 devolatilization zones, alternatively 3 to 6 devolatilization zones, and alternatively 4 to 6 devolatilization zones. Step 3) may be performed by running the TSE under vacuum and passing a stripping gas through the mixture. The stripping gas may be nitrogen, added in an amount of 0.5% to 5%, alternatively 1.5% to 3%, based on weight of the mixture. The mixture may be passed through the devolatilization zone of the TSE at a pressure of 1 torr to 300 torr, alternatively 25 torr to 100 torr, and alternatively 25 torr to 50 torr. Without wishing to be bound by theory, it is thought that the method described herein provides a benefit in that a relatively low cost vacuum system may be used (i.e., a vacuum system capable of achieving 25 to 100 torr in a TSE is typically less expensive than the vacuum system that would be required to achieve 1 torr to 5 torr in the same TSE). Furthermore, the configuration of the screws in the TSE may be designed to achieve the highest number of devolatilization stages possible without causing foaming that would result in the mixture entering devolatilization vents of the TSE. The screws comprise conveying elements and pumping elements. Conveying elements may be located between devolatilization vents such that portions of the screw are partially filled, thereby facilitating devolatilization of the mixture and allowing room for foaming of the mixture during devolatilization without the mixture backing up into the devolatilization vent. Pumping elements may be located between two devolatilization zones to fill the screw and provide a liquid seal between two conveying zones to isolate the two devolatilization zones from each other, thereby allowing for multiple devolatilization stages. The mixture may be fed through the devolatilization zone at a rate sufficient to provide a product (0.000192×D³) to (0.000384×D³), where D represents the diameter of the TSE in mm and the product is Kg/hr of carrier in the mixture. For example, in a TSE with a diameter of 25 mm, feed rate in Kg/hr of carrier in the mixture may be (0.000192×25³=3) to (0.000384×25³=6), i.e., 3 Kg/hr to 6 Kg/hr based on the amount of carrier.

Steps 2) and 3) combined are performed in a time≤180 s, alternatively 20 s to 180 s, alternatively 30 s to 120 s, and alternatively 60 s to 120 s. Without wishing to be bound by theory, it is thought that the amino-functional polyorganosiloxane is temperature sensitive and may degrade, if the amino-functional polyorganosiloxane is heated at a temperature of 100° C. or more for too long. The method described herein minimizes time at high temperature of the amino-functional polyorganosiloxane.

The devolatilized mixture produced in step 3) may be passed from the devolatilization zone to an emulsification zone of the TSE. Cooling in step 4) may be performed by a method comprising adding, water at a temperature of 0° C. to 50° C. into the TSE (downstream of the devolatilization zone and before or in the emulsification zone) and/or cooling the barrels of the TSE. The water can be added to rapidly cool, or help cool, the devolatilized mixture. Step 4) can be used to minimize residence time of the amino-functional polyorganosiloxane (in the devolatilized mixture) at high temperature. The non-ionic surfactant may be added concurrently with the water, e.g., by mixing the non-ionic surfactant with the water and feeding the resulting mixture into the twin screw extruder. Alternatively, the non-ionic surfactant may be added after the water.

Steps 4) and 5) may be performed concurrently. In addition to adding the other starting materials to the TSE at low temperature, the emulsification zone of the TSE may be externally cooled. Alternatively, step 4) may be performed before step 5).

The TSE may operate with a screw speed of 50 to 1200 rpm, alternatively 100 to 600 rpm, and alternatively 200 to 500 rpm.

The method may optionally further comprise removing the carrier after step 2). Alternatively, the carrier may be removed before step 5). The carrier may be removed by any convenient means. For example, the carrier may be removed during devolatilization in step 3), e.g., the carrier may be removed by evaporation through the devolatilization vents of the extruder along with the cyclic polydiorganosiloxanes.

The carrier may be a polydialkylsiloxane. When the carrier will be removed during devolatilization, a volatile carrier is selected, such as a polydialkylsiloxane, e.g., a trimethylsiloxy-terminated polydimethylsiloxane with suitable volatility to be removed under the devolatilization conditions. Alternatively, the polydialkylsiloxane may be included in the emulsion, in addition to the amino-functional polyorganosiloxane, the surfactant and water when the polydialkylsiloxane is not removed. Without wishing to be bound by theory, it is thought that polydialkylsiloxanes are relatively temperature stable (e.g., polydialkylsiloxanes do not degrade, or degrade less than amino-functional polyorganosiloxanes, at a temperature of >100° C. to 200° C.), and make suitable carriers that may either be removed or may form part of the emulsion, depending on the selection of polydialkylsiloxane.

### Thick Phase Emulsion

The emulsion prepared by the method described above is a thick phase emulsion. The starting materials used in the method described above may be added in amounts sufficient to provide the (thick phase) emulsion with a composition comprising≥11.7% of the amino-functional polyorganosiloxane, ≤84% of the polydialkylsiloxane, ≥0.29% of the non-ionic surfactant and ≥2.7% of the water. Alternatively, the starting materials used in the method described above may be added in amounts sufficient to provide the (thick phase) emulsion with a composition comprising 11.7% to 12% of the amino-functional polyorganosiloxane, 82% to 84% of the polydialkylsiloxane, 0.29% to 1.2% of the non-ionic surfactant, and 2.7% to 4.4% inversion water.

The siloxane phase of the thick phase emulsion prepared by the method described above may contain less than 100 ppmw each of certain cyclic polydiorganosiloxanes, i.e., D4 and D5. Alternatively, the siloxane phase of the thick phase emulsion may contain less than 100 ppmw total of D4 and D5 combined. The thick phase emulsion may have low odor, and/or good color (little yellowing) due to minimizing the time at temperature of the amino-functional polyorganosiloxane.

### Amino-Functional polyorganosiloxane

The amino-functional polyorganosiloxane used in the method described above may have formula:

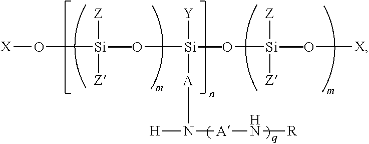

where

each A is an independently selected linear or branched alkylene group of 1 to 6 carbon atoms, optionally containing an ether linkage; each A′ is an independently selected linear or branched alkylene group of 1 to 6 carbon atoms, optionally containing an ether linkage; each Z is independently selected from the group consisting of an alkyl group, an aryl group, an aralkyl group, a halogenated alkyl group, a halogenated aryl group, and a halogenated aralkyl group; each Z′ is independently selected from the group consisting of an alkyl group, an aryl group, an aralkyl group, a halogenated alkyl group, a halogenated aryl group, and a halogenated aralkyl group; each Y is independently selected from the group consisting of, an alkyl group, an aryl group, a halogenated alkyl group, and a halogenated aryl group; each R is selected from the group consisting of hydrogen, an alkyl group of 1 to 4 carbon atoms, and a hydroxyalkyl group of 1 to 4 carbon atoms; each X is selected from the group consisting of hydrogen and an aliphatic group, optionally containing one or more ether linkages; each subscript m is 4 to 1,000; subscript n is 1 to 1,000; and each subscript q is independently 0 to 4.

Alternatively, in the formula above, each A may be an independently selected alkylene group of 2 to 4 carbon atoms, such as ethylene, propylene, or butylene, such as isobutylene). Alternatively, each A′ may be an independently selected alkylene group of 2 to 4 carbon atoms, such as ethylene, propylene, or butylene, such as isobutylene). Alternatively, each Z may be an alkyl group, such as an alkyl group of 1 to 12 carbon atoms. Alternatively, each Z may be an alkyl group of 1 to 6 carbon atoms, alternatively methyl. Alternatively, each Z′ may be an alkyl group, such as an alkyl group of 1 to 12 carbon atoms. Alternatively, each Z′ may be an alkyl group of 1 to 6 carbon atoms, alternatively methyl. Alternatively, each Y may be an alkyl group, such as an alkyl group of 1 to 12 carbon atoms. Alternatively, each Y may be an alkyl group of 1 to 6 carbon atoms, alternatively methyl. Alternatively, each X may be hydrogen or an alkyl group, such as an alkyl group of 1 to 12 carbon atoms. Alternatively, the alkyl group for X may have 1 to 12 carbon atoms. Alternatively, the alkyl group for X may have 1 to 6 carbon atoms, alternatively methyl. This amino-functional polyorganosiloxane and methods for its preparation are described in U.S. Pat. No. 7,238,768.

Alternatively, the amino-functional polyorganosiloxane (for use in the method and emulsion described herein) may be an amino-functional polydiorganosiloxane prepared by a method comprising 1) mixing and heating, at a temperature of 50° C. to 150° C., starting materials comprising: A) a silanol functional polydiorganosiloxane, B) an aminoalkyl-functional alkoxysilane, where amounts of starting materials A) and B) are such that a molar excess of silanol groups with respect to alkoxy groups is present; and thereafter 2) adding starting material D) a carboxylic acid having a pKa value of 1 to 5 and a boiling temperature of 90° C. to 150° C. at 101 kPa and; thereby forming a reaction mixture; 3) mixing and heating the reaction mixture to form the reaction product and reduce amount of residual acid to 0 to <500 ppm, based on the weight of the amino-functional polydiorganosiloxane. The starting materials may optionally further comprise C) an endblocker having triorganosilyl groups which are unreactive with silanol functionality of starting material A). Starting material C), when present, is distinct from starting material B). The starting materials used in the method described above may be free of organic alcohols such as aliphatic alcohols having 8 to 30 carbon atoms, ether alcohols, and hydroxy-terminated polyethers. “Free of organic alcohols” means that the starting materials contain no organic alcohol or an amount of organic alcohol that is non-detectable by GC. The amino-functional polydiorganosiloxane produced as described above comprises unit formula (VII): (R¹₃SiO_{1/2})ₐ(R¹₂SiO_{2/2})_{b}(R⁸R¹SiO_{2/2})_{c}(R⁸R¹₂SiO_{1/2})_{d}, where each R¹ is independently selected from a monovalent hydrocarbon group and a monovalent halogenated hydrocarbon group; the subscripts have values such that 2≥a≥0, 4000≥b≥0, 4000≥c≥0, and 2≥d≥0, with the provisos that a quantity (a+d)=2, a quantity (c+d)≥2, and a quantity 4≤(a+b+c+d)≤8000; and at least one R⁸ per molecule is a group of formula (VIII):

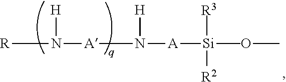

where A and A′ are each independently a linear or branched alkylene group having 1 to 6 carbon atoms and optionally containing an ether linkage; subscript q is 0 to 4; R is hydrogen, an alkyl group, or a hydroxyalkyl group having 1 to 4 carbon atoms; and R² and R³ are each independently a group —OR′ or an optionally substituted alkyl or aryl group. Alternatively, 80% to 100% of all groups R⁸ have formula (VIII). Without wishing to be bound by theory, when the endblocker C) is not used, all or substantially all of groups R⁸ have formula (VIII). Alternatively, one or more of groups R⁸ may have a formula derived from the endblocker, when it is used. For example, when a monoalkoxysilane of formula (V) is used as endblocker, some of groups R⁸ may have formula R⁴₃SiO—, where each R⁴ is independently a monovalent organic group unreactive with silanol functionality and each R⁵ is independently a monovalent hydrocarbon group of 1 to 6 carbon atoms. And, when a silazane of formula (VI) is used as endblocker, some of R⁸ may have formula R⁶⁷₂SiO—, where each R⁶ may be independently selected from the group consisting of an alkyl group, an alkenyl group, and a halogenated alkyl group; and each R⁷ is an independently selected monovalent hydrocarbon group of 1 to 6 carbon atoms. The method and the amino-functional polydiorganosiloxane produced as described herein are described in U.S. Provisional Patent Application Ser. No. 62/678,425 filed on 31 May 2018, which is hereby incorporated by reference.

Alternatively, an amino-functional polydiorganosiloxane (of the formula which is as described above with respect to U.S. Provisional Patent Application Ser. No. 62/678,425) may be prepared by the method described in U.S. Provisional Patent Application Ser. No. 62/678,430 also filed on 31 May 2018, and also hereby incorporated by reference. The amino-functional polydiorganosiloxane may be prepared by a method comprising 1) mixing and heating, at a temperature of 50° C. to 160° C., starting materials comprising: A) a silanol functional polydiorganosiloxane, B) an aminoalkyl-functional alkoxysilane, where amounts of starting materials A) and B) are such that a molar excess of silanol groups with respect to alkoxy groups is present; and 2) providing starting material D) a catalyst, thereby forming a reaction mixture; 3) mixing and heating the reaction mixture to form the reaction product; and 4) reducing amount of residual acid to 0 to <500 ppm, based on the weight of the amino-functional polydiorganosiloxane. This method may optionally further comprise adding C) and endblocker to the reaction mixture in step 1). Starting materials A), B), and C) for the method of U.S. Provisional Patent Application Ser. No. 62/678,430 are as described above in the method of U.S. Provisional Patent Application Ser. No. 62/678,425. Starting material D) for the method of U.S. Provisional Patent Application Ser. No. 62/678,430 may be prepared using a precatalyst under conditions permitting the precatalyst to react with one or more other starting materials or by-products to form D) the catalyst. The precatalyst may be an acid that is solid at ambient conditions (e.g., room temperature of 20° C. to 25° C. and 101 kPa) and melts at the reaction conditions (e.g., temperature and pressure employed in step 3) of the method) and is capable of being removed at the conditions selected in step 4) (e.g., capable of solidifying upon cooling). For example, the precatalyst may be D1) a carboxylic acid. The carboxylic acid precatalyst may have a pKa value of 1 to 7. The carboxylic acid may have a melting temperature of 40° C. to 170° C. at 101 kPa. The carboxylic acid may be an aromatic carboxylic acid. Suitable carboxylic acids include D2) benzoic acid, D3) citric acid, D4) maleic acid, D5) myristic acid, D6) salicylic acid, and D7) a combination of two or more of D2), D3), D4), D5), and D6).

Alternatively, amino-functional polyorganosiloxanes (suitable for the method for mechanically preparing an emulsion descried herein) are commercially available. For example, a trimethylsiloxy-terminated poly(dimethyl/methyl,aminoethylaminoisobutyl)siloxane having a random distribution of 2 mole % silicon atoms substituted with methyl and aminoethylaminoisobutyl groups and having sufficient molecular weight to provide a rotational viscosity of 3,000 mPa·s is commercially available as DOWSIL™ 2-8566 Amino Fluid from Dow Silicones Corporation of Midland, Mich., USA. Other amino-functional polyorganosiloxanes are also commercially available, such as XIAMETER™ OFX-8630 Polymer, Viscosity of the amino-functional polyorganosiloxane may be measured by ASTM Standard D4287 using a Brookfield Model DV3 viscometer using a CP52 spindle at a rotational speed of 0.5 RPM.

### Non-Ionic Surfactant

Suitable surfactants used in the method described herein are non-ionic surfactants. Examples of non-ionic surfactants include polyoxyalkylene alkyl phenyl ethers, polyoxyalkylene alkyl ethers such as polyethylene glycol alkyl ethers (with alkyl chains of 9 to 22 carbon atoms), polyoxyalkylene sorbitan ethers, polyoxyalkylene alkoxylate esters, polyoxyalkylene alkylphenol ethers, ethylene oxide propylene oxide copolymers, polyvinylalcohol, glyceride esters, alkylpolysaccharides, alkylglucosides, polyoxyethylene fatty acid esters, sorbitan fatty acid esters, and polyoxyethylene sorbitan fatty acid esters, an ethoxylate of a fully saturated branched primary alcohol (such as Synperonic 13/6), and a combination thereof.

Suitable non-ionic surfactants also include poly(oxyethylene)-poly(oxypropylene)-poly(oxyethylene) tri-block copolymers. Poly(oxyethylene)-poly(oxypropylene)-poly(oxyethylene) tri-block copolymers are also commonly known as Poloxamers. They are non-ionic triblock copolymers composed of a central hydrophobic chain of polyoxypropylene (poly(propylene oxide)) flanked by two hydrophilic chains of polyoxyethylene (poly(ethylene oxide)). Poly(oxyethylene)-poly(oxypropylene)-poly(oxyethylene) tri-block copolymers are commercially available from BASF (Florham Park, N.J.) and are sold under the tradenames PLURACARE™ and PLURONIC™, such as PLURONIC™ L61, L62, L64, L81, P84.

Alternatively, the non-ionic surfactants include polyoxyethylene alkyl ethers, polyoxyethylene alkylphenol ethers, polyoxyethylene lauryl ethers, polyoxyethylene sorbitan monooleates, polyoxyethylene alkyl esters, polyoxyethylene sorbitan alkyl esters, polyethylene glycol, polypropylene glycol, diethylene glycol, ethoxylated trimethylnonanols, and polyoxyalkylene glycol modified polysiloxane surfactants. Commercially available non-ionic surfactants which can be used include compositions such as 2,6,8-trimethyl-4-nonyloxy polyethylene oxyethanols (6EO) and (10EO) sold under the trademarks TERGITOL™ TMN-6 and TERGITOL™ TMN-10; alkyleneoxy polyethylene oxyethanol (C₁₁₋₁₅ secondary alcohol ethoxylates 7EO, 9EO, and 15EO) sold under the trademarks TERGITOL™ 15-S-7, TERGITOL™ 15-S-9, TERGITOL™ 15-S-15; other C₁₁₋₁₅ secondary alcohol ethoxylates sold under the trademarks TERGITOL™ 15-S-12, 15-S-20, 15-S-30, 15-S-40; and octylphenoxy polyethoxy ethanol (40EO) sold under the trademark TRITON™ X-405. All of these surfactants are sold by The Dow Chemical Company of Midland, Mich., USA. Other commercially available non-ionic surfactants include ethoxylated alcohols sold under the name Trycol 5953 by Henkel Corp./Emery Group, Cincinnati, Ohio; alkyl-oxo alcohol polyglycol ethers such as GENAPOL™ UD 050, and GENAPOL™ UD110, alkyl polyethylene glycol ether based on C10-Guerbet alcohol and ethylene oxide such as LUTENSOL™ XP 79.

Other useful commercial non-ionic surfactants are nonylphenoxy polyethoxy ethanol (10EO) sold under the trademark MAKON™ 10 by Stepan Company, Northfield, Ill.; ethoxylated alcohols sold under the name Brij™, such as polyoxyethylene 23 lauryl ether (Laureth-23) sold commercially under the trademark Brij™ L23, as well as Brij™ 35L or Brij™ L4 by Croda Inc., Edison, N.J.; and RENEX™ 30, a polyoxyethylene ether alcohol sold by ICI Surfactants, Wilmington, Del.

The non-ionic surfactant may also be a silicone polyether (SPE). The silicone polyether as an emulsifier may have a rake type structure wherein the polyoxyethylene or polyoxyethylene-polyoxypropylene copolymeric units are grafted onto the siloxane backbone, or the SPE can have an ABA block copolymeric structure wherein A represents the polyether portion and B the siloxane portion of an ABA structure. Suitable silicone polyethers include Dow Corning™ 5329 from Dow Silicones Corporation of Midland, Mich. USA. Alternatively, the non-ionic surfactant may be selected from polyoxyalkylene-substituted silicones, silicone alkanolamides, silicone esters and silicone glycosides. Such silicone-based non-ionic surfactants may be used to form such emulsions and are known in the art, and have been described, for example, in U.S. Pat. No. 4,122,029 to Gee et al., U.S. Pat. No. 5,387,417 to Rentsch, and U.S. Pat. No. 5,811,487 to Schulz et al.

One skilled in the art would recognize that certain compounds conventionally used as surfactants would not be suitable for use herein because they can act as equilibration catalysts, which could catalyze formation of cyclic polydiorganosiloxanes under the method conditions described herein. Therefore, cationic surfactants, e.g., quaternary ammonium compounds such as quaternary ammonium halides and quaternary ammonium carboxylates would not be used in the process described herein.

### Polydialkylsiloxane

The polydialkylsiloxane useful in the method described herein has unit formula (R¹₂R²SiO_{1/2})₂(R¹₂SiO_{2/2})ₓ, where each R¹ is an independently selected alkyl group of 1 to 30 carbon atoms, each R² is independently selected from the group consisting of hydroxyl and R¹, and subscript x has a value sufficient to provide the polydialkylsiloxane with desired properties. For example, when the polydialkylsiloxane is a carrier that will be removed, e.g., during the devolatilization step, subscript x may have a value sufficient to impart a viscosity <10,000 mm²/s at RT to the polydialkylsiloxane. Alternatively, when the polydialkylsiloxane will be included in the emulsion, subscript x may have a value sufficient to impart a viscosity of 50,000 mm²/s to 1,000,000 mm²/s at RT. Viscosity may be measured by ASTM Standard D4287 using a Brookfield Model DV3 viscometer using a CP52 spindle at a rotational speed of 0.5 RPM.

Suitable alkyl groups for R¹ include methyl, ethyl, propyl (e.g., iso-propyl and/or n-propyl), butyl (e.g., isobutyl, n-butyl, tert-butyl, and/or sec-butyl), pentyl (e.g., isopentyl, neopentyl, and/or tert-pentyl), hexyl, heptyl, octyl, nonyl, and decyl, and branched alkyl groups of 6 or more carbon atoms, cyclopentyl, and cyclohexyl. Alternatively, each R¹ may have 1 to 18 carbon atoms, alternatively 1 to 12 carbon atoms, alternatively 1 to 6 carbon atoms, and alternatively 1 to 4 carbon atoms. Alternatively, each R¹ may be methyl.

Subscript x represents the degree of polymerization of the polydialkylsiloxane, and when the polydialkylsiloxane will not be removed during the method and forms part of the emulsion, then subscript x is typically greater than 1000. The polydialkylsilxoane may be a trimethylsiloxy-terminated polydimethylsiloxane having a degree of polymerization (x) that is sufficient to provide a polydimethylsiloxane fluid viscosity of at least 50,000 mm²/s at RT, alternatively at least 100,000 mm²/s, and alternatively at least 500,000 mm²/s, as described above

Suitable polydialkylsiloxanes are commercially available, for example DOWSIL™ 200 Fluids are trimethylsiloxy-terminated polydimethylsiloxanes from Dow Silicones Corporation of Midland, Mich., USA. Fluids with viscosities of 50,000 mm²/s to 1,000,000 mm²/s (centiStokes) are available for use as carriers that are not removed during the method.

### Water

In step 5) of the method described above, inversion water (water in an amount of ≥2.7% water) is added to the TSE to form the thick phase emulsion. The mixture from step 4) forms a siloxane continuous phase (comprising the amino-functional polyorganosiloxane and when present the polydialkylsiloxane), and in step 5) the inversion water inverts the mixture into a discontinuous phase of siloxane droplets and a continuous phase comprising the (inversion) water forms. In the additional method steps described below, additional water may be added to dilute the thick phase emulsion to a fully diluted emulsion, which may be used in an application by a customer. This additional water is referred to as dilution water. Dilution water may be added in the TSE during or after step 5).

Alternatively, dilution water may be added in a separate unit operation. Without wishing to be bound by theory, it is thought that customers may prefer to purchase the thick phase emulsion over a fully diluted emulsion to minimize costs, such as shipping, therefore, dilution water may be added in a separate step performed by the customer. For example, because the thick phase emulsion is a siloxane in water emulsion, each customer can dilute the thick phase emulsion down to a desired concentration selected by the customer using dilution water by any convenient means, such as mixing in a conventional mixer. Alternatively, the separate unit operation may be a second twin screw extruder or other equipment for applying shear. Viscosity of the emulsion after the additional dilution step can be analyzed according to the method described in the EXAMPLES, below.

The method described above may optionally further comprise adding one or more additional materials to the emulsion (either the thick phase emulsion, or the diluted emulsion). The one or more additional materials may be a pH control agent (such as lactic acid), a preservative, a stabilizer (such as sodium benzoate), or a thickener.

The diluted emulsion described above may be formulated into personal care products, such as hair care products, exemplified by those disclosed in U.S. Pat. No. 9,017,650 at col. 6, lines 23-61 and col. 7, lines 8-21, in place of the emulsion described therein.

### EXAMPLES

These examples are intended to illustrate the invention to one skilled in the art and are not to be interpreted as limiting the scope of the invention set forth in the claims. The following starting materials are used in these examples. The polydialkylsiloxane was a trimethylsiloxy-terminated polydimethylsiloxane with a viscosity of 600,000 cSt at 25° C., commercially available as DOWSIL™ 200 Fluid from Dow Silicones Corporation of Midland, Mich., USA. The amino-functional polyorganosiloxane was DOWSIL™ 2-8566 Amino Fluid from Dow Silicones Corporation. The non-ionic surfactant was a mixture of Synperonic 13/6 and Tergitol 15-S-40. Deionized water was used.

In this Reference Example 1, 25 mL of DOWSIL™ 2-8566 was placed in a glass vial and heated for 0 to 3 hours on a hotplate at 200° C. or 300° C. while stirring with a Teflon stir bar. Samples were periodically removed at different times. The viscosity of each sample was measured on a Brookfield cone and plate viscometer model DV-III with a 40 spindle rotating at 20 rpm according to ASTM Standard D4287. The measured viscosity of each sample is reported in Table 1.

TABLE 1

| Time | Viscosity (cP) hotplate | Viscosity (cP) hotplate |
|---|---|---|
| (hr) | at 200° C. | at 300° C. |
| 0 | 219 | 219 |
| 1 | 441 | 688 |
| 3 | 580 | 1027 |

This Reference Example 1 showed that temperature and time of exposure both influenced the viscosity of the amino-functional polyorganosiloxane tested herein. Longer times and higher exposure temperatures resulted in more viscosity build, indicative of degradation of the amino-functional polyorganosiloxane.

In this Comparative Example 2, thick phase emulsion samples were prepared in a Coperion ZSK-25 (25 mm) twin screw extruder (TSE) in the following manner using the starting materials shown below in Table 2 at 3.21% inversion water in the thick phase. Four formulations of inversion water+non-ionic surfactant were prepared before preparation of the emulsion thick phase. The inversion water+non-ionic surfactant formulations used ozonated water. These formulations were designed to maintain constant non-ionic surfactant loading relative to the base recipe while varying only inversion water loading.

TABLE 2
Base Recipe

| Starting Material | weight parts |
|---|---|
| DOWSIL ™ 200 Fluid | 61.25 |
| DOWSIL ™ 2-8566 Amino Fluid | 8.75 |
| SYNPERONIC 13/6 | 0.21 |
| TERGITOL 15-S-40 (70% in ozonated water) | 1.2 |
| Inversion Water | 2 |
| Dilution Water (containing 2.35% NaBn) | 19.18 |

2-8566 aminosiloxane was loaded into a syringe pump for metering into the TSE. Inversion water+non-ionic surfactant at the inversion water wt % of interest was loaded into a separate syringe pump for metering into the TSE. 600,000 cSt 200 fluid in a drum was placed on a drum pump. The drum pump provided foreline pressure and a supply of 200 fluid to a gear pump which was used to meter the 200 fluid into an oil-heated jacketed static mixer which was used to preheat the 200 fluid to 200° C. via an oil heater. The 200 fluid then passed into the TSE after pre-heating. Prior to the experiment the gear pump was calibrated to provide mass flow rates of either 3 or 6 kg/hr depending on the run condition desired. Flow rates of aminosiloxane and water +non-ionic surfactant were chosen depending on the desired inversion water loading as well as the flow rate of 200 fluid to the TSE.

For all runs, the oil-heated heat exchanger and TSE (barrels 1-10) were heated to 200° C. TSE barrels 11-14 were cooled via cooling water to 25° C. for all runs to allow for the polymer material to cool before and during emulsification. In barrel 12, the room temperature inversion water was added, and a thermocouple in the fluid in barrel 13 indicated that the temperature was below 50° C. by this point.

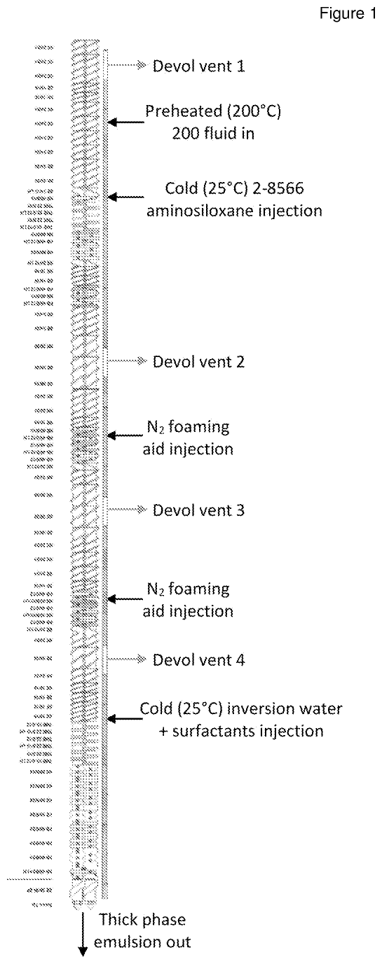

FIG. 1 shows the TSE configuration used for Comparative Examples 2 and 3 and Example 4. The TSE was a 14-barrel, 56 L/D configuration. When referring to numbering conventions below (devolatilization vent numbers, and barrel numbers), conveying direction was from lower numbers to higher numbers. The devolatilization configuration consisted of 4 vent stacks connected to 2 vacuum pumps. Devolatilization vents 1 and 2 were connected to a single vacuum line, and devolatilization vents 3 and 4 were connected to a single vacuum line. Each vacuum line passed through two condensation traps cooled by dry ice to prevent cyclosiloxanes vapors from reaching the vacuum pumps. The vacuum lines were pumped down to 50 torr during operation. Nitrogen gas was injected as a stripping aid in the mixing zones just prior to devolatilization vents 3 and 4. The nitrogen gas flow rate was regulated via rotameters and a backpressure regulator just prior to the injection port designed to inject 1.5-3 wt % nitrogen gas (as a mass fraction of the total polymer mass) at 100-150 psig into the TSE. The mixing zones between each vent stack provided enhanced surface renewal for better devolatilization, and in the case of vent stacks 3 and 4 also provided a way to mix the stripping aid into the polymer. In addition, the mixing zones provided a polymer seal such that each vent stack was isolated from the others to provide 4 independent devolatilization stages.

200 fluid was injected in barrel 2 (conveying zone), aminosiloxane in barrel 3 (mixing zone) and inversion water+non-ionic surfactants in barrel 12 (emulsification zone). Aminosiloxane and inversion water+non-ionic surfactant flow rates were controlled volumetrically via syringe pumps. When different inversion water loadings were desired, the syringe pump for water+non-ionic surfactants was emptied, flushed several times with the new water+non-ionic surfactant loading material, and then loaded with the new water+non-ionic surfactant loading material. Samples were collected for each run condition in jars at the end of the extruder. 2 replicates at each run condition were collected at least 5 minutes apart. When changing run conditions, the TSE was allowed to reach steady state for a minimum of 10 minutes before collecting a sample. For some run conditions a sample of oil without inversion water was collected for analysis of cyclics content in the polymer. To do this, the run condition was maintained with the exception that the inversion water+non-ionic surfactant syringe pump was stopped and a minimum of 10 minutes elapsed before a sample of the oil was collected. This allowed any remaining inversion water to be removed and for the TSE to reach steady state before collecting the oil sample. 2 replicates of each oil sample were collected and analyzed for cyclosiloxane determination by the acetone extraction/GC method described below.

After all runs had been collected. The particle size and particle size distribution of the thick phase material was determined by taking a small (pea sized) amount of thick phase and mixing it with 15-20 mL of dilution water in a vial. When most of the emulsion had been “dissolved” several drops of the milky silicone in water phase were placed into the sample tank of a Malvern Mastersizer particle analyzer for characterization.

To determine emulsion viscosity, each sample was placed in a mixing cup and diluted with water to final emulsion concentrations based on amount of water necessary to achieve the final polymer concentrations in the recipe in Table 2. The water was added gradually to the thick phase while mixing in a small blade mixer until the final dilution was reached. Then, a sample of the emulsion (approximately 2 g) was placed in between 2 sample pads in a CEM SMART System 5 NVC analyzer and characterized to ensure the non-volatile content was in the target range (70-73 wt %). To determine emulsion viscosity, the emulsion was placed in a 250 mL, wide-mouthed jar and placed on a Brookfield DV-I LV rotating disc viscometer. Spindle #63 was used and a rotational rate of 1-3 RPM was used to determine viscosity.

To determine dimethyl linear and cyclic siloxane species within the siloxane phase, the inversion water to the extruder was shut off and oil phase samples at various run conditions were collected from the end of the extruder. The samples were taken through an acetone extraction technique using dodecane as an internal standard. External calibrants were prepared and analyzed in the same manner as the samples. All weights were recorded using a four-place balance. Analysis was performed on an Agilent 6890 gas chromatograph equipped with flame ionization detection. The chromatograms were processed and quantified using Thermo Atlas.

Approximately 0.5 g of sample was treated with ˜0.05 g of internal standard solution containing 28000 ppmw dodecane in acetone. An additional 2 g of acetone was added, and the sample was shaken for over two hours at room temperature on a wrist action shaker. The samples were then centrifuged and the clear acetone layer was placed into autosampler vials. Analysis was done using GC-FID with the parameters detailed below. A method blank containing only internal standard and acetone was prepared in order to determine the amount of interference to the peaks of interest as part of background noise (if present).

Pre-made, community stock solutions were used to create calibration standards. The initial stock solution of cyclosiloxanes and linear siloxanes was prepared in acetone with 1 g each of D4, D5, and D6 diluted in 2 g of acetone. Serial dilutions were made to create standards ranging from 100,000 ppmw to 1 ppmw of the indicated components. The concentrations selected for this analysis included 10 ppmw, 100 ppmw, 1000 ppmw, and 10000 ppmw. Aliquots of these standards were prepared in the same manner as the samples.

Prior to analysis, the existing inlet liner was replaced with a clean liner containing a glass wool and Chromasorb filter. 1 μL of the prepared sample was injected onto the GC column (DB-1, 30 m×0.25 mm×0.1 μm coating) on an inlet at 250° C. with a 50:1 split ratio. The carrier gas was helium flowing at 1.5 mL/min. The oven was ramped according to the following program: 1) 50° C., 1 minute hold, 2) Ramp to 300° C. at 15° C./min and hold for 10 minutes, 3) Ramp to 305° C. at 15° C./min and hold for 5 minutes. The detector was an FID at 300° C.

Flame ionization detection is non-selective. Peaks were identified by retention time matching to reference materials found in the standards. The calibration standards were used to determine experimental response factors relative to the internal standard. These values were used to quantify D4, D5, and D6. All other peaks were quantified using theoretical response factors relative to the internal standard, calculated using the molecular weight of the component and the number of carbons it contained. The samples prepared in Comparative Example 1 are summarized below in Table 3.

Comparative example 2 showed that when the amount of inversion water was too low (i.e., ≥2.7% in the thick phase emulsion), the resulting diluted emulsion (prepared after dilution of the thick phase) had an undesirably high viscosity, ≥45,900 cP. The inventors surprisingly found that the amount of inversion water added to the TSE in the method described herein could impact viscosity of the diluted emulsion.

In this Comparative Example 3, a baseline condition (condition 0, high cyclics/with no devolatilization) was tested to show the effect of putting the materials through the TSE in FIG. 1 without devolatilization.

The heat exchanger and TSE were left unheated (25° C.) to produce an emulsion without devolatilization. To determine dimethyl cyclic siloxane species within the siloxane phase, the inversion water to the extruder was shut off and 2 oil phase samples separated by 5 minutes were collected from the end of the extruder. The samples were taken through an acetone extraction technique using dodecane as an internal standard. External calibrants were prepared and analyzed in the same manner as the samples. All weights were recorded using a four-place balance. Analysis was performed on an Agilent 6890 gas chromatograph equipped with flame ionization detection. The chromatograms were processed and quantified using Thermo Atlas.

Approximately 0.5 g of sample was treated with ˜0.05g of internal standard solution containing ˜28000 ppmw dodecane in acetone. An additional 2 g of acetone was added, and the sample was shaken for over two hours at room temperature on a wrist action shaker. The samples were then centrifuged and the clear acetone layer was placed into autosampler vials. Analysis was done using GC-FID with the parameters detailed below. A method blank containing only internal standard and acetone was prepared in order to determine the amount of interference to the peaks of interest as part of background noise (if present).

Pre-made, community stock solutions were used to create calibration standards. The initial stock solution of cyclosiloxanes and linear siloxanes was prepared in acetone with ˜1 g each of D4, D5, and D6 diluted in 2 g of acetone. Serial dilutions were made to create standards ranging from 100000 ppmw to 1 ppmw of the indicated components. The concentrations selected for this analysis included 10 ppmw, 100 ppmw, 1000 ppmw, and 10000 ppmw. Aliquots of these standards were prepared in the same manner as the samples.

Prior to analysis, the existing inlet liner was replaced with a clean liner containing a glass wool and Chromasorb filter. 1 μL of the prepared sample was injected onto the GC column (DB-1, 30 m×0.25 mm×0.1 μm coating) on an inlet at 250° C. with a 50:1 split ratio. The carrier gas was helium flowing at 1.5 mL/min. The oven was ramped according to the following program: 1) 50° C., 1 minute hold, 2) Ramp to 300° C. at 15° C./min and hold for 10 minutes, 3) Ramp to 305° C. at 15° C./min and hold for 5 minutes. The detector was an FID at 300° C.

Flame ionization detection is non-selective. Peaks were identified by retention time matching to reference materials found in the standards. The calibration standards were used to determine experimental response factors relative to the internal standard. These values were used to quantify D4, D5, and D6. All other peaks were quantified using theoretical response factors relative to the internal standard, calculated using the molecular weight of the component and the number of carbons it contained. The samples prepared in Comparative Example 3 are summarized below in Table 4. The cyclic siloxane content results of the samples prepared in Comparative Example 3 are in Table 5 presented as ppmw of the sample, as received.

In this example 4, working examples were prepared using the TSE in FIG. 1 using the screw speeds, feed rates of polydialkylsiloxane and inversion water content specified in Table 6, with the devolatilization temperature at 200° C. The samples prepared in example 4 are summarized below in Table 6. The cyclic siloxane content results of the samples prepared in example 4 are in Table 7 presented as ppmw of the siloxane oil phase sample.

To determine dimethyl cyclic siloxane species within the siloxane phase, the inversion water to the extruder was shut off and 2 oil phase samples separated by 5 minutes were collected from the end of the extruder. The samples were taken through an acetone extraction technique using dodecane as an internal standard. External calibrants were prepared and analyzed in the same manner as the samples. All weights were recorded using a four-place balance. Analysis was performed on an Agilent 6890 gas chromatograph equipped with flame ionization detection. The chromatograms were processed and quantified using Thermo Atlas. Approximately 0.5 g of sample was treated with ˜0.05 g of internal standard solution containing ˜28000 ppmw dodecane in acetone. An additional 2 g of acetone was added, and the sample was shaken for over two hours at room temperature on a wrist action shaker. The samples were then centrifuged and the clear acetone layer was placed into autosampler vials. Analysis was done using GC-FID with the parameters detailed below. A method blank containing only internal standard and acetone was prepared in order to determine the amount of interference to the peaks of interest as part of background noise (if present).

Pre-made, community stock solutions were used to create calibration standards. The initial stock solution of cyclosiloxanes and linear siloxanes was prepared in acetone with ˜1 g each of D4, D5, and D6 diluted in 2 g of acetone. Serial dilutions were made to create standards ranging from 100000 ppmw to 1 ppmw of the indicated components. The concentrations selected for this analysis included 10 ppmw, 100 ppmw, 1000 ppmw, and 10000 ppmw. Aliquots of these standards were prepared in the same manner as the samples.

Prior to analysis, the existing inlet liner was replaced with a clean liner containing a glass wool and Chromasorb filter. 1 μL of the prepared sample was injected onto the GC column (DB-1, 30 m×0.25 mm×0.1 μm coating) on an inlet at 250° C. with a 50:1 split ratio. The carrier gas was helium flowing at 1.5 mL/min. The oven was ramped according to the following program: 1) 50° C., 1 minute hold, 2) Ramp to 300° C. at 15° C./min and hold for 10 minutes, 3) Ramp to 305° C. at 15° C./min and hold for 5 minutes. The detector was an FID at 300° C.

Flame ionization detection is non-selective. Peaks were identified by retention time matching to reference materials found in the standards. The calibration standards were used to determine experimental response factors relative to the internal standard. These values were used to quantify D4, D5, and D6. All other peaks were quantified using theoretical response factors relative to the internal standard, calculated using the molecular weight of the component and the number of carbons it contained.

TABLE 3
Samples Prepared in Comparative Example 1

| | Temp | Feed | Screw | Inversion | Particle Size | | | Span | Thick phase | Water | NVC | Viscosity |
|---|---|---|---|---|---|---|---|---|---|---|---|---|
| No. | (C.) | rate | speed | water (%) | D10 | D50 | D90 | (%) | mass (g) | added (g) | (wt %) | (cp) |
| 9a | 200 | 3 | 200 | 2.75 | 1.470 | 2.126 | 3.045 | 74.1 | 120.01 | 42.34 | 71.87 | 51000 |
| 9b | 200 | 3 | 200 | 2.75 | 1.461 | 2.120 | 3.047 | 74.8 | 121.83 | 42.95 | 71.75 | 53900 |
| 11a | 200 | 3 | 500 | 2.75 | 1.267 | 1.768 | 2.444 | 66.6 | 121.07 | 42.75 | 71.73 | 46300 |
| 11b | 200 | 3 | 500 | 2.75 | 1.229 | 1.769 | 2.519 | 72.9 | 122.23 | 43.10 | 71.80 | 53100 |
| 13a | 200 | 6 | 200 | 2.75 | 1.483 | 2.163 | 3.117 | 75.5 | 120.26 | 42.43 | 71.77 | 47500 |
| 13b | 200 | 6 | 200 | 2.75 | 1.495 | 2.175 | 3.139 | 75.6 | 120.05 | 42.36 | 71.80 | 52200 |
| 15a | 200 | 6 | 500 | 2.75 | 1.308 | 1.835 | 2.553 | 67.8 | 121.50 | 42.89 | 72.18 | 49600 |
| 15b | 200 | 6 | 500 | 2.75 | 1.320 | 1.859 | 2.597 | 68.7 | 120.84 | 42.64 | 71.97 | 45900 |

TABLE 4
Comparative Example 3 Emulsion Preparation Conditions

| | Temp | Feed | Screw | Inversion | Particle Size | | | Span | Thick phase | Water | NVC | Viscosity |
|---|---|---|---|---|---|---|---|---|---|---|---|---|
| No. | (C.) | rate | speed | water (%) | D10 | D50 | D90 | (%) | mass (g) | added (g) | (wt %) | (cp) |
| 0a | *25 | 3 | 200 | 3.21 | 1.626 | 2.457 | 3.671 | 83.2 | 117.12 | 40.55 | 71.45 | 51000 |
| 0b | *25 | 3 | 200 | 3.21 | 1.495 | 2.340 | 3.637 | 91.5 | 120.70 | 40.82 | 72.23 | 53700 |

*Denotes a control sample prepared with unstripped material.

TABLE 5
Results of Comparative Example 3

| No. | D4 | D5 | D6 |
|---|---|---|---|
| 0a | 370 | 730 | 1000 |
| 0b | 370 | 720 | 1000 |

TABLE 6
Working Example Emulsion Preparation Conditions

| | Temp | Feed | Screw | Inversion | Particle Size | | | Span | Thick phase | Water | NVC | Viscosity |
|---|---|---|---|---|---|---|---|---|---|---|---|---|
| No. | (C.) | rate | speed | water (%) | D10 | D50 | D90 | (%) | mass (g) | added (g) | (wt %) | (cp) |
| 1a | 200 | 3 | 200 | 3.21 | 1.703 | 2.567 | 3.831 | 82.9 | 117.19 | 40.60 | 71.61 | 37000 |
| 1b | 200 | 3 | 200 | 3.21 | 1.665 | 2.585 | 3.962 | 88.9 | 119.45 | 41.36 | 71.77 | 28400 |
| 2a | 200 | 3 | 500 | 3.21 | 1.409 | 2.033 | 2.898 | 73.2 | 120.33 | 41.65 | 71.99 | 45400 |
| 2b | 200 | 3 | 500 | 3.21 | 1.390 | 2.005 | 2.860 | 73.3 | 120.63 | 41.80 | 72.13 | 34500 |
| 3a | 200 | 3 | 200 | 4.25 | 2.252 | 3.394 | 5.238 | 88.0 | 125.39 | 41.62 | 71.81 | 28600 |
| 3b | 200 | 3 | 200 | 4.25 | 2.409 | 3.681 | 5.763 | 91.1 | 121.70 | 40.44 | 71.93 | 27900 |
| 4a | 200 | 3 | 500 | 4.25 | 1.689 | 2.548 | 3.809 | 83.2 | 125.18 | 41.60 | 72.48 | 33300 |
| 4b | 200 | 3 | 500 | 4.25 | 1.812 | 2.563 | 3.601 | 69.8 | 123.31 | 40.93 | 72.17 | 33000 |
| 5a | 200 | 6 | 200 | 3.21 | 1.698 | 2.620 | 4.043 | 89.5 | 120.24 | 41.67 | 71.80 | 35000 |
| 5b | 200 | 6 | 200 | 3.21 | 1.682 | 2.587 | 3.959 | 88.0 | 120.70 | 41.81 | 71.77 | 31700 |
| 6a | 200 | 6 | 500 | 3.21 | 1.436 | 2.090 | 3.007 | 75.2 | 120.98 | 41.93 | 72.03 | 40200 |
| 6b | 200 | 6 | 500 | 3.21 | 1.438 | 2.090 | 3.000 | 74.7 | 120.26 | 41.67 | 71.78 | 32600 |
| 7a | 200 | 6 | 200 | 4.25 | 2.245 | 3.933 | 6.953 | 119.7 | 124.54 | 41.35 | 71.77 | 23100 |
| 7b | 200 | 6 | 200 | 4.25 | 2.213 | 3.816 | 6.667 | 116.7 | 126.94 | 42.14 | 71.78 | 26000 |
| 8a | 200 | 6 | 500 | 4.25 | 1.800 | 2.658 | 3.918 | 79.7 | 122.90 | 40.82 | 72.12 | 32700 |
| 8b | 200 | 6 | 500 | 4.25 | 1.804 | 2.669 | 3.930 | 79.7 | 124.98 | 41.52 | 72.41 | 28100 |
| 10a | 200 | 3 | 200 | 3.75 | 1.945 | 2.885 | 4.324 | 82.5 | 121.49 | 41.18 | 71.67 | 32600 |
| 10b | 200 | 3 | 200 | 3.75 | 1.945 | 2.908 | 4.421 | 85.1 | 122.26 | 41.45 | 71.90 | 28300 |
| 12a | 200 | 3 | 500 | 3.75 | 1.586 | 2.305 | 3.305 | 74.6 | 122.68 | 41.57 | 72.00 | 40200 |
| 12b | 200 | 3 | 500 | 3.75 | 1.541 | 2.229 | 3.190 | 74.0 | 122.21 | 41.43 | 72.15 | 38200 |
| 14a | 200 | 6 | 200 | 3.75 | 2.217 | 3.401 | 5.340 | 91.8 | 123.64 | 41.91 | 71.81 | 33000 |
| 14b | 200 | 6 | 200 | 3.75 | 2.206 | 3.381 | 5.289 | 91.2 | 120.02 | 40.70 | 71.80 | 36500 |
| 16a | 200 | 6 | 500 | 3.75 | 1.643 | 2.400 | 3.476 | 76.4 | 121.32 | 41.15 | 72.07 | 36700 |
| 16b | 200 | 6 | 500 | 3.75 | 1.634 | 2.387 | 3.450 | 76.1 | 122.54 | 41.56 | 72.06 | 33900 |

TABLE 7
Results of Example 4

| No. | D4 | D5 | Combined Content of D4 and D5 | D6 |
|---|---|---|---|---|
| 1a, 3a, 10a | 10 | 20 | 30 | 50 |
| 1b, 3b, 10b | 10 | 20 | 30 | 60 |
| 2a, 4a, 12a | 0 | 0 | 0 | 20 |
| 2b, 4b, 12b | 0 | 0 | 0 | 20 |
| 6a, 8a, 15a, 16a | 10 | 20 | 30 | 80 |
| 6b, 8b, 15b, 16b | 10 | 20 | 20 | 80 |
| 5a, 7a, 13a, 14a | 20 | 80 | 100 | 180 |
| 5b, 7b, 13b, 14b | 20 | 70 | 90 | 160 |

These examples showed that the method described herein achieved the benefit of reducing D4 content to <100 ppmw and reducing D5 content to <100 ppmw in the samples tested in example 4. When conditions were optimized to ensure sufficient residence time in the devolatilization zone (e.g., by increasing screw speed, decreasing feed rate, or both, D4 content and D5 content combined could be reduced to <100 ppmw, and D6 content can also be reduced to <100 ppmw under these conditions.

### INDUSTRIAL APPLICABILITY

A method for mechanically making an emulsion of an amino-functional polyorganosiloxane comprises devolatilizing amino-functional polyorganosiloxane to remove cyclic polydiorganosiloxanes and emulsifying the devolatilized amino-functional polyorganosiloxane with starting materials comprising a non-ionic surfactant and water, where the method steps of devolatilizing and emulsifying are performed in one twin screw extruder. Because amino-functional polyorganosiloxanes, particularly those having primary and/or secondary amino-functionality, may be unstable when exposed to relatively high temperatures, the amino-functional polyorganosiloxane described herein is devolatilized at an elevated temperature for a time≤180 s and then rapidly cooled. Because the amino-functional polyorganosiloxane spends less time at elevated temperatures than in previous methods, degradation of amino-functional polyorganosiloxane is minimized or eliminated. However, the method is effective to remove cyclic polyorganosiloxanes, namely D4 and D5 to low levels, e.g., the thick phase emulsion prepared in the twin screw extruder contains an amount of each of D4 and D5≤100 ppmw. The emulsions produced by the method described herein may be suitable for use in hair care compositions, such as hair conditioners.

### Definitions and Usage of Terms

All amounts, ratios, and percentages herein are by weight, unless otherwise indicated. The SUMMARY and ABSTRACT are hereby incorporated by reference. The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The abbreviations used herein have the definitions in Table 8.

TABLE 8
Abbreviations

| Abbreviation | Definition |
|---|---|
| cP | centiPoise |
| D4 | octamethylcyclotetrasiloxane of |
| | formula [(CH₃)₂SiO_{2/2}]₄ |
| D5 | decamethylcyclopentasiloxane of |
| | formula [(CH₃)₂SiO_{2/2}]₅ |
| D6 | dodecamethylcyclohexasiloxane |
| | of formula [(CH₃)₂SiO_{2/2}]₆ |
| DP | degree of polymerization |
| GC | gas chromatography |
| hr | hour(s) |
| Kg | kilograms |
| mL | milliliter(s) |
| mm | millimeter(s) |
| MM | hexamethyldisiloxane |
| PPmw | part(s) per million by weight |
| RPM | revolution(s) per minute |
| RT | room temperature of 23° C. |
| s | second(s) |
| μL | microliters |
| μm | micrometers |

### Embodiments of the Invention

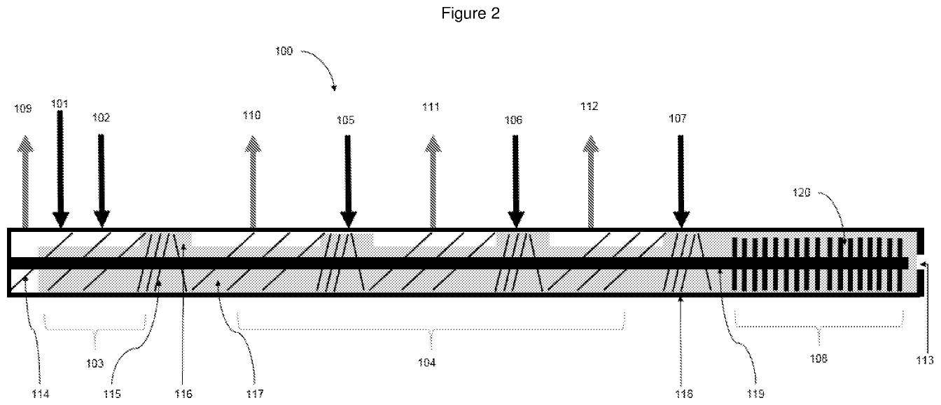

In a first embodiment, FIG. 2 shows a twin screw extruder 100, which comprises a barrel 118 housing a screw 119 longitudinally oriented therein. The twin screw extruder 100 comprises contiguous zones (including a mixing zone 103, devolatilization zone 104 and emulsification zone 108) inside the barrel 119, through which starting materials can pass as they are conveyed by the screw 119. The screw 119 has conveying elements 114, pumping elements 115, and emulsifying elements 120 configured to rotate on its axis. The twin screw extruder 100 has a first inlet port 101 and a second inlet port 102 for feeding starting materials into the mixing zone 103. A conveying element 114 is located on the screw 119 under the first inlet port 101 and the second inlet port 102. The carrier can be fed into the mixing zone 103 of the twin screw extruder 101 through the first inlet port 101. The amino-functional polyorganosiloxane can be fed into the mixing zone 103 of the twin screw extruder through the second inlet port 102. The carrier may be heated by a heating apparatus (not shown) before being fed into the first inlet port 101. Alternatively, the carrier may be heated by externally heating the mixing zone 103 at the first inlet port and/or by shaft work of the screw 119.

The twin screw extruder 100 further comprises a devolatilization zone 104 downstream of the mixing zone 103. The devolatilization zone 104 has at least one devolatilization vent 110 for withdrawing gas and/or volatile components out of the twin screw extruder 100. The devolatilization zone has at least one stripping gas inlet 105, 106 for adding nitrogen or other stripping gas into the devolatilization zone 104. The screw 119 has pumping elements 115 underneath the stripping gas inlets 105, 106. The pumping elements 115 cause a liquid seal 116 to form at each stripping gas inlet 105, 106. Cyclic polydiorganosiloxanes are removed through the devolatilization vents 110, 111, 112. The resulting devolatilized mixture of carrier and amino-functional polyorganosiloxane is conveyed by the screw 119 into the emulsification zone 108.

The emulsification zone 108 is downstream of the devolatilization zone 104. The emulsification zone 108 has a third inlet port 107 into the twin screw extruder 100. The twin screw extruder 100 further comprises an outlet port 113 downstream of the emulsification zone 108. The twin screw extruder may optionally further comprise an additional devolatilization vent 109 in the mixing zone, and one or more additional devolatilization vents 111 and 112 in the devolatilization zone.

In a second embodiment a method for mechanically preparing an emulsion of an amino-functional polyorganosiloxane, using one twin screw extruder 100 as described above, comprises:

i) heating a carrier to a temperature of >100° C. to 300° C.;

ii) feeding the carrier into the mixing zone 103 through the first inlet port 101;

iii) feeding an amino-functional polyorganosiloxane at a temperature of 20° C. to 50° C. into the mixing zone through the second inlet port 102, thereby forming a mixture of the amino-functional polyorganosiloxane and the carrier in the mixing zone 103 at a devolatilization temperature of 100° C. to 200° C.;

iv) devolatilizing the mixture in the devolatilization zone 104;

where steps 3) to 4) are performed in a time of 180 s;

v) cooling the mixture to less than 50° C. in the emulsification zone 108;

vi) feeding starting materials comprising a non-ionic surfactant and water into the emulsification zone 108 through the third inlet port 107;

vii) emulsifying the starting materials comprising the amino-functional polyorganosiloxane, the non-ionic surfactant, and the water in the emulsification zone 108; and

viii) decanting the emulsion from the twin screw extruder 100 through the outlet port 113.

In a third embodiment, the temperature in step i) is >100 to 200° C.

In a fourth embodiment, steps 3) to 4) are performed in the time of ≤120 s.

1. A method for mechanically preparing an emulsion of an amino-functional polyorganosiloxane, the method comprising:
1) heating a carrier to a temperature of >100° C. to 300° C.;
2) mixing the amino-functional polyorganosiloxane at a temperature of 20° C. to 50° C. and the carrier heated in step 1), thereby forming a mixture comprising the amino-functional polyorganosiloxane and the carrier at a devolatilization temperature of 100° C. to 200° C.;
3) devolatilizing the mixture;
where steps 2) and 3) combined are performed in a time of ≤180 seconds;
4) cooling the mixture to a temperature less than 50° C.;
5) emulsifying starting materials comprising the amino-functional polyorganosiloxane, a non-ionic surfactant, and water, thereby preparing a thick phase emulsion, where the water is present in an amount≥2.7% in the thick phase emulsion; and
where steps 2) to 5) are performed in one twin screw extruder.

2. The method of claim 1, where the carrier is a polydialkylsiloxane.

3. The method of claim 1, where step 1) is performed before feeding the carrier into the one twin screw extruder.

4. The method of claim 1, where step 1) is performed in the one twin screw extruder.

5. The method of claim 1, where cooling in step 4) comprises adding the water at a temperature of 0° C. to 50° C.

6. The method of claim 1, further comprising removing all or a portion of the carrier after step 2).

7. The method of claim 1, where the starting materials are added in amounts sufficient to provide the emulsion with a composition comprising
11.7 to 12% of the amino-functional polyorganosiloxane,
82 to 84% of the polydialkylsiloxane,
0.29 to 1.2% of the non-ionic surfactant, and
>2.7 to 4.4% water.

8. The method of claim 1, where the amino-functional polyorganosiloxane has formula: 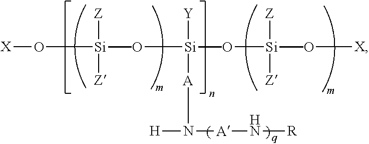
where
each A is an independently selected linear or branched alkylene group of 1 to 6 carbon atoms, optionally containing an ether linkage;
each A′ is an independently selected linear or branched alkylene group of 1 to 6 carbon atoms, optionally containing an ether linkage;
each Z is independently selected from the group consisting of an alkyl group, an aryl group, an aralkyl group, a halogenated alkyl group, a halogenated aryl group, and a halogenated aralkyl group;
each Z′ is independently selected from the group consisting of an alkyl group, an aryl group, an aralkyl group, a halogenated alkyl group, a halogenated aryl group, and a halogenated aralkyl group;
each Y is independently selected from the group consisting of, an alkyl group, an aryl group, a halogenated alkyl group, and a halogenated aryl group;
each R is selected from the group consisting of hydrogen, an alkyl group of 1 to 4 carbon atoms, and a hydroxyalkyl group of 1 to 4 carbon atoms;
each X is selected from the group consisting of hydrogen and an aliphatic group, optionally containing one or more ether linkages;
each subscript m is independently 4 to 1,000;
subscript n is 1 to 1,000; and
each subscript q is independently 0 to 4.

9. The method of claim 1, where the non-ionic surfactant is selected from the group consisting of an ethoxylate of a fully saturated branched primary alcohol, a secondary alcohol ethoxylate, and a combination thereof.

10. The method of claim 1, where the polydialkylsiloxane has unit formula (R¹₂R²SiO_{1/2})₂(R¹₂SiO_{2/2})ₓ, where each R¹ is an independently selected alkyl group of 1 to 30 carbon atoms, each R² is independently selected from the group consisting of hydroxy and R¹, and subscript x has a value sufficient to provide the polydialkylsiloxane with a viscosity of 50,000 mm2/s to 1,000,000 mm2/s at 23° C. as measured by ASTM Standard D4287 using a Brookfield Model DV3 viscometer using a CP52 spindle at a rotational speed of 0.5 RPM.

11. A thick phase emulsion prepared by a method comprising:
1) heating a carrier to a temperature of >100° C. to 300° C.;
2) mixing the amino-functional polyorganosiloxane at a temperature of 20° C. to 50° C. and the carrier heated in step 1), thereby forming a mixture comprising the amino-functional polyorganosiloxane and the carrier at a devolatilization temperature of 100° C. to 200° C.;
3) devolatilizing the mixture;
where steps 2) and 3) combined are performed in a time of ≤180 seconds;
4) cooling the mixture to a temperature less than 50° C.;
5) emulsifying starting materials comprising the amino-functional polyorganosiloxane, a non-ionic surfactant, and water, thereby preparing a thick phase emulsion, where the water is present in an amount≥2.7% in the thick phase emulsion; and
where steps 2) to 5) are performed in one twin screw extruder.

12. A method of preparing a silicone in water emulsion comprising: diluting the thick phase emulsion of claim 11 with additional water and applying shear.

13. A silicone in water emulsion prepared by the method of claim 12.

14. The emulsion of claim 11, where the emulsion has a siloxane phase that contains less than 100 ppmw each of octamethylcyclotetrasiloxane and decamethylcyclopentasiloxane.

15. The emulsion of claim 14, where the emulsion has a siloxane phase that contains less than or equal to 100 ppmw of octamethylcyclotetrasiloxane and decamethylcyclopentasiloxane combined.
